(19) United States
(12) Patent Application Publication
(10) Pub. No.: US 2013/0172165 A1
(43) Pub. Date: Jul. 4, 2013

(54) METHOD FOR PRODUCING TRIANGULAR PACKAGING BAGS AND ASSEMBLY THEREFOR

(71) Applicant: Klaus Hamm, Weinstadt (DE)

(72) Inventor: Klaus Hamm, Weinstadt (DE)

(73) Assignees: NESTEC S.A., Vevey (CH); HARRO HOFLIGER VERPACKUNGSMASCHINEN GMBH, Allmersbach im Tal (DE)

(21) Appl. No.: 13/509,744

(22) PCT Filed: Nov. 10, 2010
(86) PCT No.: PCT/EP10/06847

§ 371 Date: Feb. 26, 2013

(30) Foreign Application Priority Data
Nov. 14, 2009 (DE) 10 2009 053 405.9

(51) Int. Cl. B31B 25/00

(52) U.S. Cl. CPC B31B 25/00
USPC 493/267; 493/186

(57) ABSTRACT

The invention relates to a method for producing packaging bags (1, 1′) having a triangular outline, made of a film strip having two longitudinal edges (3, 4) located opposite of each other. The film strip (2) is wound about a shaping mandrel forming a film spiral (5). The film spiral (5) is pulled off the shaping mandrel so far that a first seam section (7) formed by the longitudinal edges (3, 4) and extending in the circumferential direction about 180° around the film spiral (5) and a first film section opposite of the first seam section (7) are exposed and sealed there. The film spiral (5) is further pulled off the shaping mandrel so far that a second seam section (10) abutting the first seam section (7) and a second film section (11) located opposite of the second seam section (10) are exposed and also sealed.

The invention relates to a method for producing packaging bags having a triangular outline from a film strip, and also to an arrangement for producing such packaging bags by this method.

Various pulverulent, granular, piece-form or liquid materials are packaged in what are known as tubular-bag packs, in which a film strip is formed into a tube. This tube is sealed off at transverse seams such that a closed packaging space for holding the pack contents is produced. The film tube sealed off in this way can be severed at the transverse seams selectively to form individual tubular-bag packs. Alternatively, a perforation can be introduced instead of a severing cut. This results in what is known as a chain pack, from which the individual packaging bags can be torn off as required.

If the sealing seams are introduced transversely to the longitudinal direction of the film tube, packaging bags having a rectangular outline are produced. However, for certain applications, packaging bags having a triangular outline may be desired. To this end, the sealing seams should be arranged in a zigzag shape at a particular angle to the longitudinal axis of the film tube. According to the prior art, first of all a film strip is formed into a tube, with the longitudinal edges of the film strip being sealed together to form a longitudinal seam. Subsequently, on either side, a diagonally extending sealing seam that crosses the longitudinal seam is introduced, the packaging bag is filled and finally the latter is sealed off by way of a further sealing seam that extends likewise diagonally but is inclined in the opposite direction.

In order that the pack contents can fall into the bag interior, the film tube is guided vertically, that is to say parallel to the weight force direction, during the packaging process. In this case, the diagonal sealing seams of the triangular packaging bags extend obliquely to the direction of gravity, thereby making it harder or impossible to completely fill the packaging bag. There is the risk of the pack contents reaching the seal portion of the diagonally extending transverse sealing seams, as a result of which it is harder or impossible to seal off the filled pack in a leaktight manner. Therefore, tubular-bag packs having a triangular outline have to have an oversize, resulting in too much film material being used. This circumstance is exacerbated by further film material being used for producing the longitudinal sealing seam.

A further problem is that in some cases incomplete filling or even filling that has not occurred at all can be observed. Such individual packaging bags that are not filled or are not filled properly have to be separated out. This is significant in particular when chain packs, in which every single packaging bag has to be filled, are intended to be produced. In this case, the entire chain pack has to be separated out, and this can considerably increase the associated waste costs.

It is the object of the invention to specify a method by means of which packaging bags having a triangular outline can be produced and also filled in an easy and reliable manner.

This object is achieved by a method having the features of claim 1.

It is a further object of the invention to specify an arrangement for carrying out the method according to the invention, by means of which method packaging bags having a triangular outline can be manufactured and filled in a reliable manner.

This object is achieved by an arrangement having the features of claim 10.

According to the invention, it is proposed that a film strip be wound around a forming mandrel, forming a film coil, such that its longitudinal edges adjoin one another. The film coil is pulled off the forming mandrel until a first seam portion formed by the longitudinal edges and extending through 180° in the circumferential direction around the film coil, and also a first film portion opposite the first seam portion are exposed. The film coil is compressed in the region of the first seam portion, the first seam portion being sealed off from the first film portion, forming a first sealing seam. The film coil is furthermore pulled off the forming mandrel until a second seam portion formed by the longitudinal edge, extending through 180° in the circumferential direction around the film coil and adjoining the first seam portion, and also a second film portion opposite the second seam portion are exposed. The film coil is compressed in the region of the second seam portion, the second seam portion being sealed off from the second film portion, forming a second sealing seam that intersects the first sealing seam.

The associated arrangement comprises a feeding device, held in particular in a stationary manner, for a film strip, a forming mandrel which is rotatable in particular about its longitudinal axis and is axially displaceable in the direction of the longitudinal axis, a control device for forming a film coil during the winding of the film strip onto the forming mandrel, and also a sealing device, arranged in the region of an outlet-side end of the forming mandrel, for sealing off the film coil, forming the packaging bags.

On account of the production of the film coil, it is possible to dispense with the longitudinal seam which is required according to the prior art, while a closed film tube is nevertheless formed. All that has to take place is sealing off at the two mentioned sealing portions, thereby contributing to the saving of material and reduction in the consumption of film. The film coil pulled off the forming mandrel is forcibly held open by the forming mandrel in the region of the second sealing seam after the formation of the first sealing seam, such that it is possible to fill the packaging bags in a secure manner without waste. The packaging bags having a triangular outline can be manufactured and filled in a highly economical and reliable manner.

In an advantageous development of the invention, the film coil is rotated through 180°, with respect to its longitudinal axis, between the sealing off of the first seam portion and the sealing off of the second seam portion. The packaging bag to be produced has a central length, wherein in particular the forming mandrel together with the film coil is displaced axially about said central length of the packaging bag, starting from a starting position, during said 180° rotation, wherein the film coil is retained in this rotated and in particular axially displaced state, and wherein subsequently the forming mandrel and the film coil are axially displaced with respect to one another such that the film coil is pulled axially off the forming mandrel by said central length.

In the associated arrangement, the film coil has a coil pitch, wherein the control device is designed such that the feeding device and the forming mandrel, together with the film coil, are displaced axially with respect to one another by half the coil pitch upon a rotation through 180° starting from a starting position.

As a result, each individual sealing operation is always performed in the same spatial position. The sealing seams to be sealed off in each case are positioned in the same position for each sealing operation, and so it is possible to work with the same and fixedly arranged sealing device.

In a preferred embodiment, the forming mandrel is arranged in a manner inclined at an inclination angle with respect to the horizontal such that the first or second seam portion lies horizontally during the sealing off operation. In the associated arrangement, the film coil has a pitch angle, wherein the inclination angle of the forming mandrel is equal to the pitch angle of the film coil. In particular, the sealing device is arranged horizontally in this case. The overall result of this is that the sealing seam to be sealed off in each case lies horizontally. Before sealing off, the triangular packaging bag can therefore be filled virtually to the top, without the pack contents falling out of the interior of the still open, not yet sealed off packaging bag. Furthermore, even at a high filling level, none of the pack contents can reach the region of the sealing seam. In spite of the high filling level, the triangular packaging bag can be closed or sealed off in a reliable and leaktight manner. For a particular quantity of the pack contents, the packaging bag can be configured in a comparatively small manner, thereby further reducing the consumption of film material.

In an expedient development of the invention, the forming mandrel is in the form of a forming tube, wherein the packaging bag is filled through the forming tube before the second sealing seam is closed. To this end, within the forming tube there is arranged a filling line for filling the packaging bag through the forming tube. Consequently, forcible filling of the packaging bag spread apart by the forming tube is ensured, without the still open, spread-apart seal portion being contaminated with the pack contents. The filling contents cannot pass to the side of the packaging bag, thereby ensuring reliable filling and subsequent, likewise reliable sealing off of the film bag.

In a preferred embodiment, the forming mandrel is configured as a radially widenable forming tube that is formed in particular from radially displaceable segments. The effective diameter of the forming tube is corrected or readjusted during the winding of the film coil in order to achieve a desired winding pattern. This is advantageous in particular when a particular pattern has to be applied to the film strip in a particular relative position in relation to the packaging bag. By adapting the effective winding diameter in a controlled or regulated manner, a reduced or increased length of the film strip is wound for each revolution, as a result of which a printed pattern applied to the film strip can be moved to the desired position or its position can be corrected.

In order to form the film coil, the longitudinal edges of the film strip are expediently stuck together, and in particular sealed together in an overlapping manner, on the forming mandrel. To this end, radially on the outside of the forming mandrel, there is advantageously arranged a sealing device for fixing the film strip in the form of the film coil. This ensures that the film coil retains its form not only on the forming mandrel or on the forming tube, but also after it has been pulled off the latter until the sealing seams are formed, thereby contributing to the reliability of the process.

In an advantageous embodiment of the arrangement, on that side of the sealing device that is remote from the outlet-side end of the forming mandrel, there is arranged a supporting device for the sealed off film strip, in particular in the form of a guide tube. The weight of the sealed off and filled film strip is supported as a result, such that its inherent weight does not act on the not yet sealed film coil. The sealing operation can be performed in an unimpaired manner.

On that side of the sealing device that is remote from the outlet-side end of the forming mandrel, there is advantageously arranged a retaining device for the sealed off film strip, in particular in the form of clamping jaws. Once the forming mandrel, together with the film coil, has performed its combined rotational and axial movement, the already sealed off film strip is grasped or fixed by the retaining device. In this state, the forming mandrel can be pulled back into its starting position, without the film coil being pulled with it. Instead, the film coil remains in place and is in the process pulled off the forming mandrel, such that the next, subsequent sealing seam can be completed.

In order to make the abovementioned process easier, the forming mandrel is configured preferably as a radially widenable forming tube that is formed in particular from radially displaceable segments. In this case, the film coil is wound onto the radially widened forming tube. When the film coil is pulled off the forming tube, the segments are pushed radially inwards, such that the effective diameter of the forming tube is reduced. This makes it easier to pull back the forming tube without the film coil being entrained in the process.

In a preferred embodiment, in the region of the outlet-side end of the forming mandrel, there is arranged a spreading device for the film coil. This facilitates a fold-free sealing off of the sealing seams.

Optionally, with the method according to the invention and with the arrangement according to the invention, a perforation can be arranged between the adjoining sealing seams in order to form a chain pack comprising a plurality of packaging bags or a severing cut can be carried out in order to form individual packaging bags. The invention is very versatile as a result.

Exemplary embodiments of the invention are described in more detail in the following text on the basis of the drawing, in which:

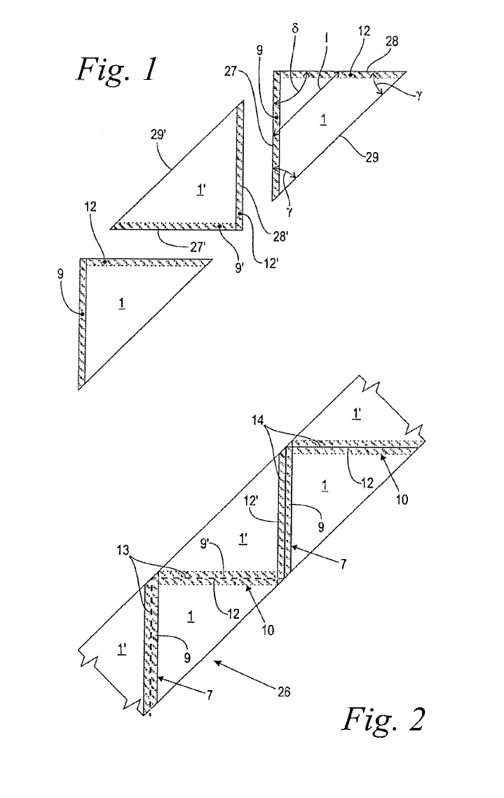

FIG. 1 shows a schematic plan view of individual packaging bags having a triangular outline, which are produced according to the invention from a film strip wound to form a film coil;

FIG. 2 shows a schematic plan view of a chain pack having contiguous packaging bags according to FIG. 1;

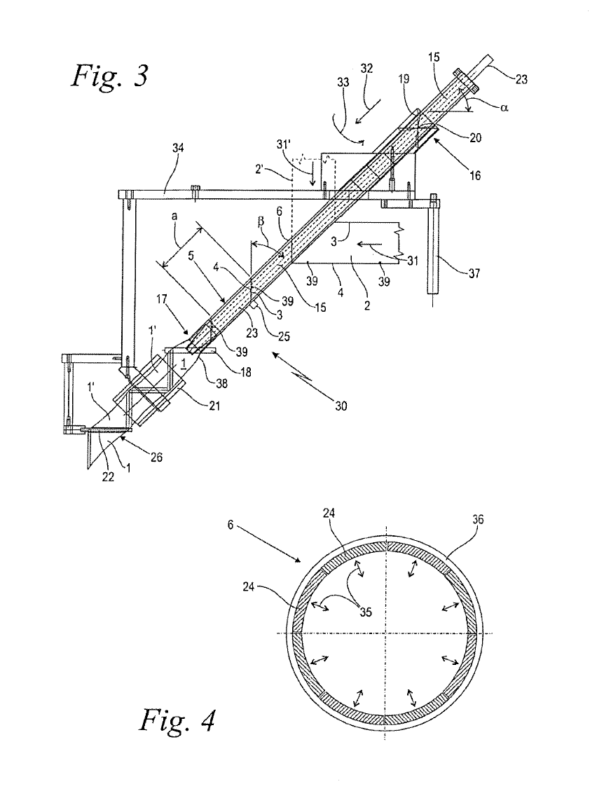

FIG. 3 shows a side view of an arrangement according to the invention for producing the packaging bags according to FIGS. 1 and 2 with a suitable forming tube and a film coil wound obliquely onto the forming tube;

FIG. 4 shows a schematic cross-sectional illustration of the forming tube according to FIG. 3 with individual segments that can be displaced in the radial direction;

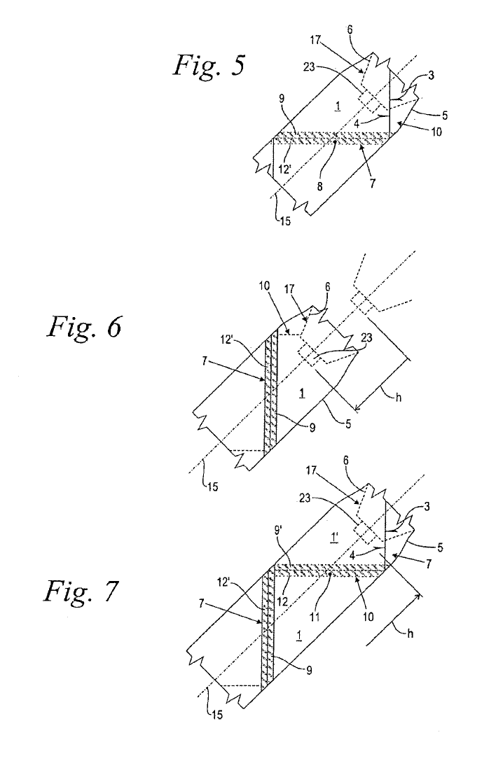

FIG. 5 shows a schematic detail illustration of the arrangement according to FIG. 3 in the region of the forming tube end during the formation of a first sealing seam;

FIG. 6 shows the arrangement according to FIG. 5, in which the film coil and the forming tube have been displaced axially and rotated through 180° in order to fill the packaging bag;

FIG. 7 shows the arrangement according to FIG. 6 with the forming tube pulled back during the sealing off of the second sealing seam;

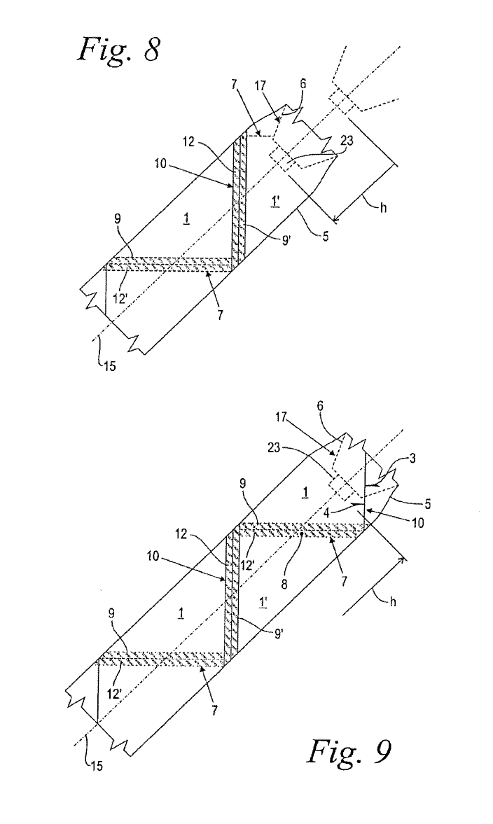

FIG. 8 shows the arrangement according to FIG. 7, in which the forming tube and the film coil have been axial displaced again and rotated through 180° in order to fill the next packaging bag;

FIG. 9 shows the arrangement according to FIG. 8 with the forming tube pulled back during the sealing off of the next sealing seam.

FIG. 1 shows a schematic plan view of a plurality of packaging bags 1, 1′ having a triangular outline, which are produced according to the invention from a film strip 2 illustrated in FIG. 3. In the exemplary embodiment shown, the packaging bags 1, 1′ are filled with coffee powder. However, they can also contain a different, pulverulent, granular, piece-form or liquid filling material.

The packaging bags 1, 1′ are configured in one part. To this end, the film material of the film strip 2 (FIG. 3) is turned over in a seamless manner at a folded edge 29 and is sealed together or sealed off in a leaktight manner at two adjoining seam edges 27, 28 by way of a first sealing seam 9, 9′ and a second sealing seam 12, 12′ that intersects the first sealing seam 9, 9′. As a result of the folded edge 29 and the sealing seams 9, 9′, 12, 12′, hermetically closed interiors, in which the filling material is stored, are produced in the packaging bags 1, 1′.

The outline of the packaging bags 1, 1′ is given by the edges 27, 27′, 28, 28′, 29, 29′, which are arranged in the form of an isosceles triangle. The two seam edges 27, 28 of the packaging bag 1 enclose a corner angle δ, which is 90° in the exemplary embodiment shown but may also have a different value. The folded edge 29 encloses with the seam edges 27, 28 in each case an acute angle γ, which is 45° in the exemplary embodiment shown but may likewise have a different value. The same applies in a corresponding manner to the packaging bags 1′ with their seam edges 27′, 28′ and their folded edges 29′.

FIG. 2 shows a schematic plan view of a chain pack 26 which is formed by joined-together packaging bags 1, 1′ according to FIG. 1. The packaging bags 1, 1′ are in this case arranged in a row such that the first sealing seam 9 of the packaging bag 1 adjoins the second sealing seam 12′ of the adjacent packaging bag 1′, while the second sealing seam 12′ of the packaging bag 1′ adjoins the first sealing seam 9 of the adjacent packaging bag 1. A first seam portion 7 is formed where the first sealing seam 9 of the packaging bag 1 adjoins the second sealing seam 12′ of the packaging bag 1′, while a second seam portion 10 is formed where the first sealing seam 9′ of the packaging bag 1′ adjoins the second sealing seam 12 of the packaging bag 1. If a chain pack 26 having triangular packaging bags 1, 1′ arranged alongside one another in a row according to FIG. 2 is intended to be produced, the first seam portions 7 are provided between the mutually adjoining sealing seams 9, 12′ and the second seam portions 10 are provided between the mutually adjoining sealing seams 9′, 12, in each case with an interrupted perforation 13. As a result of this, the packaging bags 1, 1′ are linked together in the form of the chain pack 26, but can be separated from one another as required by being torn off manually.

Alternatively, in each case a severing cut can be carried out along a cutting line 14 in the first seam portions 7 between the mutually adjoining sealing seams 9, 12′ and in the second seam portions 10 between the mutually adjoining sealing seams 9′, 12, as is illustrated by way of a solid line likewise in FIG. 2. On account of the severing cut along the cutting lines 14, the packaging bags 1, 1′ are separated out as per the illustration in FIG. 1.

FIG. 3 shows a side view of an exemplary embodiment of an arrangement according to the invention for producing and filling the packaging bags 1, 1′ according to FIGS. 1 and 2. The arrangement comprises a packaging machine 30 and a film strip 2. The packaging machine 30 has a frame 34, on which a forming mandrel is rotatable about its longitudinal axis 15 and is mounted in an axially displaceable manner in the direction of the longitudinal axis 15. The forming mandrel can be configured in a solid manner and is configured in the exemplary embodiment shown as a forming tube 6 that is described in more detail below. The longitudinal axis 15 of the forming tube 6 is inclined at an inclination angle α with respect to the horizontal, said angle α being 45° in the exemplary embodiment shown. A film strip 2 is fed horizontally in the direction of an arrow 31 to the forming tube 6 by means of a feeding device 37 held in a stationary position on the frame 34, and is wound helically onto the outer circumferential surface of the forming tube 6 by the latter being rotated and simultaneously axially displaced in the direction of the arrows 33, 32, as a result of which a film coil 5 is formed there. Alternatively, a film strip 2′ can also be fed to the forming tube 6 vertically, in the direction of an arrow 31′, or from some other direction. Furthermore, an arrangement in which the forming tube 6 is held in a stationary position on the frame 34 and in which the feeding device 37 is guided around the forming tube 6 in order to form the film coil 5 may also be expedient. In each case, a control device 16 ensures that both the feeding device 37 and the forming tube 6, together with the film coil 5, are displaced axially with respect to one another or in relation to one another by half a coil pitch a upon a rotation through 180° starting from a starting position.

The film strip 2 is bounded by two laterally opposite longitudinal edges 3, 4 which define the width of the film strip 2. The width of the film strip 2, the diameter of the forming tube 6 and the feeding angle of the film strip 2 to the forming tube 6 are matched to one another such that the film strip 2 is wound around the forming tube 6, forming the film coil 5, such that the longitudinal edge 4 of one film turn adjoins the longitudinal edge 3 of the adjacent film turn. In the exemplary embodiment shown, the longitudinal edge 4 within the film coil 5 overlaps the adjacent longitudinal edge 3, illustrated by dashed lines, by a particular given amount. There, a sealing device 25 for mutually fixing the overlapping longitudinal edges 3, 4 is arranged radially on the outside of the forming tube 6. By means of the schematically indicated sealing device 25, the overlapping longitudinal edges 3, 4 of the film strip 2 are stuck together on the forming tube 6 by a sealing operation in order to form the film coil 5. Instead of a sealing operation using hot or cold seal adhesive, some other suitable form of sticking may be expedient, optionally also with the overlapping of the longitudinal edges 3, 4 being dispensed with.

The film coil 5 wound onto the forming tube 6 lies with the longitudinal edges 3, 4 at a pitch angle β in relation to the longitudinal axis 15 of the forming tube 6. This and the circumference of the forming tube 6 furthermore result in a coil pitch a, measured in the direction of the longitudinal axis 15, as the distance between two adjoining film turns. The pitch angle β defines in an identical manner the point angle γ, illustrated in FIG. 1, of the packaging bags 1, 1′, and is thus selected to be 45° here. Of course, a different angle β can also be set by geometric adaptation. Furthermore, the packaging bags 1, 1′ according to FIG. 1 have a central length l measured parallel to the folded edge 29. The coil pitch a (FIG. 3) is twice said central length l.

The packaging machine 30 is provided with a control device 16 for forming the film coil 5 when the film strip 2 is wound onto the forming tube 6. The control device 16 causes the forming tube 6 to be displaced in a uniform manner axially in the direction of an arrow 32 upon a rotation in the direction of the arrow 33. The rotary movement in the direction of the arrow 33 and the axial displacement movement in the direction of the arrow 32 are coupled together such that the film strip can be kept in its spatial position in an unchanged manner without refeeding, is merely pulled off from the feeding device 37 in the direction of the arrow 31 in the process and is wound onto the forming tube 6 to form the uniform film coil 5. The control device 16 can be controlled electronically and be driven in a coordinated manner in both degrees of freedom of movement for example via stepping motors. In the exemplary embodiment shown, the control device 16 is formed by a helical coiling surface 19 and a guide mandrel 20 abutting the coiling surface 19. The coiling surface 19 is connected firmly to the frame 34, while the guide mandrel 20 is connected firmly to the forming tube 6. However, a converse configuration may also be expedient. The coiling surface 19 extends through 180° around the longitudinal axis 15 and in the process extends in the axial direction over half the coil pitch a. Upon a rotation of the forming tube 6 through 180°, the guide mandrel 20 abutting the coiling surface 19 leads to said rotary movement in the direction of the arrow 33 being converted into an axial travel in the direction of the arrow 32, said axial travel amounting to half the coil pitch a.

It can be seen from viewing FIG. 3 in conjunction with FIG. 4 that the forming tube 6 is configured in a cylindrical manner in that region in which the film coil 5 is formed by winding the film strip 2. However, some other cross-sectional form may also be expedient. In the region of its lower, outlet-side end 17, the cross section of the forming tube 6 can optionally be narrowed. In the region of this narrowed end 17 there is arranged a sealing device 18 for sealing off the film coil 5, forming the packaging bags 1, 1′ (FIGS. 1 and 2). In order to support this sealing operation, a spreading device 38 for the film coil 5 is also arranged in the region of the outlet-side end 17, said spreading device 38 being formed by a pair of spreading fingers in the exemplary embodiment shown. By means of the spreading device 38, the initially cylindrical film coil 5 is spread out on the input side of the sealing device 18 to form a flat, double-layered web, and is fed to the sealing device 18 in this spread-out state.

Furthermore, within the forming tube 6, an indicated filling line 23 for filling the packaging bags 1, 1′ extends through the forming tube 6. The function of the last-mentioned components is described in more detail further below.

FIG. 5 shows a schematic and enlarged detail view of the arrangement according to FIG. 3 in the region of the lower end 17 of the forming tube 6 having the lower end of the filling line 23. The film coil 5 has been pulled so far off the forming mandrel 6, over the end 17 of the latter, that a first seam portion 7 formed by the longitudinal edges 3, 4 (FIG. 3) and extending through 180° around the film coil 5 in the circumferential direction is exposed, that is to say is no longer supported by the forming tube 6. The first seam portion 7 is located here on that side of the film coil 5 that faces away from the viewer and therefore is illustrated with dashed lines. Opposite the first seam portion 7 is a continuous, uninterrupted first film portion 8. The first film portion 8 is located on that side of the film coil 5 that faces the viewer and, just like the first seam portion 7, is not supported by the forming tube 6, and therefore is exposed.

It can be seen from viewing FIGS. 3 and 5 together that the inclination angle α of the forming tube 6 is selected to be equal to the pitch angle β of the film coil 5, and accordingly the first seam portion 7 (FIG. 5) lies horizontally in this state. The sealing device 18 illustrated in FIG. 3 also extends horizontally and thus spans the first seam portion 7 (FIG. 5). The sealing device 18 (FIG. 3) comprises two sealing jaws (not illustrated in more detail), between which the film coil 5 spread out and folded flat by means of the spreading device 38 (FIG. 3) is guided through. By compression of the sealing jaws, the film coil 5 is also compressed in the region of the first seam portion 7 in a manner corresponding to the illustration according to FIG. 5, with the first seam portion 7 being sealed against the first film portion 8. In this case, a first sealing seam 9 of the packaging bag 1 and also a second sealing seam 12′ are formed. As a result, the packaging bag 1 is sealed off in a leaktight manner at its first sealing seam 9. For the sealing operation, the film strip 2 (FIG. 3) is provided on its inside with a sealing layer, which may be configured as a cold or hot sealing film. Other sealing aids may also be expedient.

Furthermore, the horizontally extending first seam portion 7 is adjoined by a second seam portion 10 which, in the position according to FIG. 5, extends vertically over the end 17 of the forming tube 6, that is to say is still supported by the forming tube 6.

Starting from the initial situation according to FIG. 5, the arrangement shown there is rotated about the longitudinal axis 15 through an angle of 180°, as is illustrated in FIG. 6. As a consequence, the control device 16 (FIG. 3) causes the forming tube 6 to execute an axial travel h in the direction of the longitudinal axis 15, starting from the starting position according to FIG. 5, together with the film coil 5 and the filling line 23, said axial travel h being equal to half the coil pitch a (FIG. 3) and thus equal to the central length l (FIG. 1). In the rotated position according to FIG. 6, the first seam portion 7 lies vertically, while the adjoining second seam portion 10 of the packaging bag 1 extends horizontally. Since the second seam portion 10 furthermore extends over the end 17 of the forming tube 6, the packaging bag 1 is widened in the region of the second seam portion 10, such that a filling opening of the packaging bag 1 is formed. Moreover, the end of the filling line 23 projects into the interior of the not yet closed packaging bag 1. The packaging bag 1 is filled through the filling line 23 in the state according to FIG. 6. As a result of the horizontal position of the second seam portion 10, this filling can take place virtually completely, without the filling material emerging from the open second seam portion 10 or contaminating the second seam portion 10.

FIG. 3 indicates a retaining device for the sealed off film strip 2, said retaining device being configured in the form of a pair of clamping jaws 22 in the exemplary embodiment shown. In the filled state according to FIG. 6, the film strip 2 (FIG. 3) or the chain pack 26 formed therefrom is firmly held by means of the clamping jaws 22. In this case, the forming tube 6, together with the filling line 23, is then pulled back axially, starting from the position according to FIG. 6, by the length of the travel h, as is illustrated in FIG. 7. Conversely, if an embodiment having a fixed forming tube 6 is provided, the film coil 5 is pulled off the forming tube 6 by means of a retaining device that can be displaced by the length of the travel h. In each case, an axial relative displacement takes place between the film coil 5 and the forming tube 6 such that, as a result, the film coil 5 is pulled off the forming tube 6 by the length of the travel h or by the central length l.

In order that this is easily possible without the film coil 5 slipping, the forming mandrel is configured as a radially widenable forming tube 6 which is formed here from radially displaceable segments 24. A schematic cross-sectional illustration of this embodiment of the forming tube 6 is shown in FIG. 4.

Accordingly, the forming tube 6 is composed cross-sectionally of for example eight segments 24 here, which are mounted in a radially movable manner corresponding to double arrows 35. On the outside, the segments 24 are surrounded by an elastic, cylindrical cover 36 which can be formed for example from elastic silicone plastic or the like. In the cross-sectional state widened radially to a nominal degree, the film coil 5 (FIG. 3) is wound onto the outer surface of the elastic cover 36. When the forming tube 6 is pulled back axially in accordance with the illustration in FIG. 7, the segments 24 (FIG. 4) are displaced radially inwards, the outside diameter of the elastic cover 36 also becoming smaller. However, if appropriate, it is also possible to dispense with the elastic cover 36, in which case the film coil 5 (FIG. 3) then rests directly on the outer surfaces of the segments 24. In each case, the radially inwardly directed movement of the segments 24 causes the cross section of the forming tube 6 to become smaller, as a result of which no appreciable static friction occurs any longer between the film coil 5 and the outer surface of the forming tube 6 when the film coil 5 is pulled off. It takes little effort to pull the forming tube 6 back axially by the length of the travel h, in accordance with the illustration in FIG. 7, without the film coil 5 (FIG. 3) fixed by the clamping jaws 22 being pulled back along therewith.

Accordingly, there ensues the state according to FIG. 7, in which the film coil 5 has been pulled so far from the forming tube 6 by the length of the travel h that now the second seam portion 10 that is formed by the longitudinal edges 3, 4, extends in the circumferential direction through 180° around the film coil 5 and adjoins the first seam portion 7 is also exposed. The second seam portion 10 is located opposite a continuous, likewise exposed film portion 11, the same applying to the second seam portion 10 and the second film portion 11 as was stated for the first seam portion 7 and the first film portion 8 in conjunction with FIG. 5. The second seam portion 10 intersects the first seam portion 7. According to the illustration in FIG. 7, the second seam portion 10 also lies horizontally and the sealing device 18 (FIG. 3) engages over it. The film coil 5 is now compressed in the region of the second seam portion 10, with the second seam portion 10 being sealed off with respect to the second film portion 11, forming the second sealing seam 12 intersecting the first sealing seam 9. As a result, the packaging bag 1 provided according to FIG. 5 by means of the first sealing seam 9 and filled according to FIG. 6 is closed and completely sealed off. Moreover, the last-mentioned sealing operation in the second seam portion 10 simultaneously also forms the first sealing seam 9′ of the following packaging bag 1′.

In a comparable manner to the illustration in FIG. 6, starting from the position in FIG. 7, the arrangement is rotated once more through 180° about the longitudinal axis 5 and in the process is displaced axially by the length of the travel h, such that the second seam portion 10 now comes to lie vertically in accordance with the illustration in FIG. 8. This vertical second seam portion 10 is adjoined again by a first, horizontally extending seam portion 7, within which the end 17 of the forming tube 6 is located in a comparable manner to the illustration in FIG. 6. In this position, the packaging bag 1′ following the already filled packaging bag 1 and provided by the first sealing seam 9′ is now filled in a comparable manner to the arrangement in FIG. 6.

Furthermore, the film strip 2 or the chain pack 26 (FIG. 3) is again firmly held by the clamping jaws 22, in order to allow the guide tube 6 to be pulled back axially by the length of the travel h, in a manner corresponding to the illustration in FIG. 9, after the packaging bag 1 has been filled. In the state according to FIG. 9, the now horizontal first seam portion 7 is sealed off in a comparable manner to the illustrations in FIGS. 5 and 7, a second sealing seam 12′, intersecting the first sealing seam 9′, of the packaging bag 1′ being produced, and by way of which the packaging bag 1′ is then closed. At the same time, the first sealing seam 9 of the following, not yet filled packaging bag 1 is also formed, whereby a complete sealing cycle is concluded. The state in FIG. 9 thus corresponds to the starting state in FIG. 5.

The cycle according to FIGS. 5 to 9 can be repeated as often as desired, until a chain pack 26 (FIG. 2) having a desired length or a desired number of individual packaging bags 1, 1′ (FIG. 1) has/have been produced.

It is also apparent from the illustration in FIG. 3 that, on that side of the sealing device 18 that faces away from the outlet-side end 17 of the forming tube 6, a supporting device for the sealed-off film strip 2 or for the filled chain pack 26 formed therefrom is arranged between said sealing device and the clamping pack 22. In the exemplary embodiment shown, this supporting device is embodied in the form of a guide tube 21, through which the sealed-off film strip 2 is guided. The guide tube 21 is rotated synchronously together with the forming tube 6 and supports the weight of the film strip 2, which has been processed to form triangular packaging bags 1, 1′ and filled, such that the film coil 5 is relieved of load in particular in the region of the sealing device 18.

With simultaneous reference to FIGS. 2 and 3, it should also be stated that the severing cut at the cutting line 14 or the perforation 13 can be carried out on the outlet side of the clamping jaws 22 or directly at the clamping jaws 22. In the latter case, the clamping jaws 22 are provided for this purpose with a severing cutter (not illustrated). If a chain pack 26 is intended to be produced and therefore only a perforation 13 is intended to be introduced, the perforation 13 can also be carried out by appropriate cutters on the sealing device 18.

It is also apparent from FIG. 3 that the film strip 2 is provided at regular intervals with printing marks 39, indicated here. When the film strip 2 is printed with a printed pattern (not illustrated), it can be desired for this printed pattern to be positioned in a particular repeating position on the packaging bags 1, 1′ (FIGS. 1 and 2), it being intended for this to be ensured by way of the printing marks 39 and for example an opto-electronic printing mark detector (not illustrated). It can be seen in FIG. 3 that the printing marks 39 in the region of the film coil 5 are always in the same circumferential position on the forming tube 6. As a result, the abovementioned printed pattern is also always positioned in the desired position on the packaging bags 1, 1′ (FIGS. 1 and 2). However, deviations of the position of the printing marks 39 from their desired position on the forming tube 6 can occur, and these can be detected by the abovementioned printing mark detector.

The length of the film strip 2 taken from the feeding device 37 and wound depends functionally directly on the effective circumference of the forming tube 6. By way of a control device or by way of a control loop, the effective diameter or circumference of the forming tube 6, the cross section of which is settable, according to FIG. 4 can be tracked by way of the printing mark detection such that upon every rotation of the forming tube 6 a greater or shorter length of the film strip 2 is wound. This length adaptation can be carried out such that the abovementioned deviations can be compensated and the printing marks 39 are located at their provided desired position. In this way, exact positioning of the printed pattern on the packaging bags 1, 1′ (FIGS. 1 and 2) is ensured.

1. A method for producing packaging bags having a triangular outline from a film strip having two opposing longitudinal edges, comprising the steps:
winding the film strip around a forming mandrel, forming a film coil, such that its longitudinal edges adjoin one another;
pulling the film coil off the forming mandrel until a first seam portion formed by the longitudinal edges and extending through 180° in the circumferential direction around the film coil, and also a first film portion opposite the first seam portion are exposed;
compressing the film coil in a region of the first seam portion, the first seam portion being sealed off from the first film portion, forming a first sealing seam;
pulling the film coil off the forming mandrel until a second seam portion formed by the longitudinal edges, extending through 180° in the circumferential direction around the film coil and adjoining the first seam portion, and also a second film portion opposite the second seam portion are exposed;
compressing the film coil in a region of the second seam portion, the second seam portion being sealed off from the second film portion, and forming a second sealing seam that intersects the first sealing seam.

2. The method as claimed in claim 1, wherein the film coil is rotated through 180°, with respect to its longitudinal axis, between the sealing off of the first sealing seam and the sealing off of the second sealing seam.

3. The method as claimed in claim 2, wherein the packaging bag has a central length, in that the forming mandrel is rotated together with the film coil through 180° and in the process these are displaced axially about the central length, in particular from a starting position, in that the film coil is retained in this rotated and displaced state, and subsequently the forming mandrel and the film coil are axially displaced with respect to one another such that the film coil is pulled axially off the forming mandrel by the central length.

4. The method as claimed in claim 2, wherein the forming mandrel is arranged in a manner inclined at an inclination angle with respect to the horizontal such that the first or second seam portion lies horizontally during the sealing off operation.

5. The method as claimed in claim 1, wherein the forming mandrel is in the form of a forming tube, and in that the packaging bag is filled through the forming tube before the second sealing seam is closed.

6. The method as claimed in claim 1, wherein the forming mandrel is configured as a radially widenable forming tube that is formed from radially displaceable segments, and in that the effective diameter of the forming tube can be corrected or readjusted during the winding of the film coil in order to achieve a desired winding pattern.

7. The method as claimed in claim 1, wherein the longitudinal edges of the film strip are stuck together, and sealed together in an overlapping manner, in order to form the film coil on the forming mandrel.

8. The method as claimed in claim 1, wherein the first and second seam portions have, between the adjoining sealing seams, with a perforation, in order to form a chain pack comprising a plurality of packaging bags.

9. The method as claimed in claim 1, wherein, in the first and second seam portions, a severing cut is carried out, between the adjoining sealing seams, along a cutting line, in order to form individual packaging bags.

10. An arrangement for producing packaging bags having a triangular outline comprising a forming mandrel, a feeding device for a film strip having longitudinal edges, a control device for forming a film coil during the winding of the film strip onto the forming mandrel such that the longitudinal edges of the film strip adjoin one another, and also a sealing device, arranged in the region of an outlet-side end of the forming mandrel, for sealing off the film coil, forming the packaging bags, wherein the sealing device is designed such that, by way of the sealing device, a first seam portion formed by the longitudinal edges and extending through 180° in the circumferential direction around the film coil is sealed off from a first film portion opposite the first seam portion, and such that, by way of the sealing device, a second seam portion formed by the longitudinal edges, extending through 180° in the circumferential direction around the film coil and adjoining the first seam portion is sealed off from a second film portion opposite the second seam portion.

11. The arrangement as claimed in claim 10, wherein the feeding device for the film strips is held in a stationary position, and the forming mandrel for forming the film coil is rotatable about its longitudinal axis and is mounted in an axially displaceable manner in the direction of its longitudinal axis.

12. The arrangement as claimed in claim 10, wherein the film coil has a coil pitch, and the control device is designed such that the feeding device and the forming mandrel, together with the film coil, are displaced axially with respect to one another by half the coil pitch upon a rotation through 180° starting from a starting position.

13. The arrangement as claimed in claim 12, wherein the control device is formed by a coiling surface and a guide mandrel abutting the coiling surface.

14. The arrangement as claimed in claim 10, wherein the film coil has a pitch angle, and the forming mandrel is inclined at an inclination angle with respect to the horizontal, wherein the inclination angle is equal to the pitch angle.

15. The arrangement as claimed in claim 14, wherein the sealing device is arranged horizontally.

16. The arrangement as claimed in claim 10, wherein, on that side of the sealing device that is remote from the outlet-side end of the forming mandrel, there is arranged a supporting device for the sealed off film strip.

17. The arrangement as claimed in claim 10, wherein, on that side of the sealing device that is remote from the outlet-side end of the forming mandrel, there is arranged a retaining device for the sealed off film strip.

18. The arrangement as claimed in claim 10, wherein the forming mandrel is in the form of a forming tube, and, within the forming tube, there is arranged a filling line for filling the packaging bag through the forming tube.

19. The arrangement as claimed in claim 10, wherein the forming mandrel is configured as a radially widenable forming tube that is formed in particular from radially displaceable segments.

20. The arrangement as claimed in claim 10, wherein, radially on the outside of the forming mandrel, there is arranged a sealing device for fixing the film strip in the form of the film coil.

21. The arrangement as claimed in claim 10, wherein, in the region of the outlet-side end of the forming mandrel, there is arranged a spreading device for the film coil.
